(19) United States
(12) Patent Application Publication
(10) Pub. No.: US 2002/0072535 A1
(43) Pub. Date: Jun. 13, 2002

(54) Fungicide active substance combinations

(76) Inventors: Klaus Stenzel, Dusseldorf (DE); Stefan Dutzmann, Langenfeld (DE); Astrid Mauler-Machnik, Leichlingen (DE); Lutz Abmann, St.Peter-Ording (DE)

Correspondence Address: BAYER CORPORATION, PATENT DEPARTMENT, 100 BAYER ROAD, PITTSBURGH, PA, 15205, US

(21) Appl. No.: 09/882,042

(22) Filed: Jun. 14, 2001

Related U.S. Application Data
(62) Division of application No. 09/402,908, filed on Oct. 13, 1999.

(30) Foreign Application Priority Data
Apr. 18, 1997 (DE) 197 16 256.8

(51) Int. Cl. A01N 43/52; A01N 43/00; A01N 43/54; A01N 43/82; A01N 43/64; A01N 47/10

(52) U.S. Cl. 514/394; 514/395; 514/383; 514/491; 514/183; 514/361; 514/269

(57) ABSTRACT

The novel active compound combinations consisting of a halogeno-benzimidazole of the formula

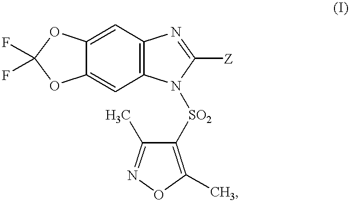

in which

Z represents chlorine or bromine,

and the active compound groups (1) to (25) listed in the description have very good fungicidal properties.

The present invention relates to novel active compound combinations which comprise known halogeno-benzimidazoles and further known fungicidally active compounds, and which are highly suitable for controlling phytopathogenic fungi.

It is already known that 1-(3,5-dimethyl-isoxaole-4-sulphonyl)2-bromo-6,6-difluoro-[1,3]-dioxolo-[4,5f]-benzimidazole and 1-(3,5-dimethyl-isoxaole-4-sulphonyl)-2-chloro-6,6-difluoro-[1,3]-dioxolo-[4,5f]-benzimidazole have fungicidal properties (cf. WO 97-06171) The activity of these compounds is good; however, at low application rates it is in some cases not satisfactory.

Furthermore, it is already known that a large number of triazole derivatives, aniline derivatives, dicarboximides and other heterocycles can be employed for controlling fungi (cf. EP-A 0 040 345, DE-A 2 201 063, DE-A 2 324 0 10, Pesticide Manual, 9th Edition (1991), pages 249 and 827, EP-A 0 382 375 and EP-A 0 515 901). Likewise, the activity of these compounds is not always satisfactory at low application rates.

Finally, it is also known that 1-[(6-chloro-3-pyridinyl)-methyl]-N-nitro-2-imidazolidineimine can be used for controlling animal pests suck as insects (cf. Pesticide Manual, 9th Edition (1991), page 491). However, fungicidal properties have not hitherto been described for this compound.

It has now been found that the novel active compound combinations consisting of a halogeno-benzimidazole of the formula

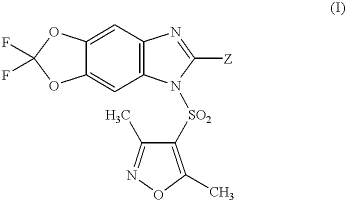

in which

Z represents chlorine or bromine, and

(1) a triazole derivative of the formula

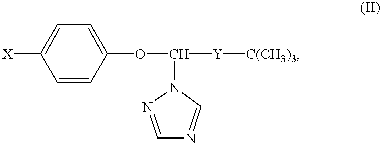

in which

X represents chlorine or phenyl, and

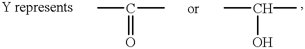

and/or

(2) the triazole derivative of the formula

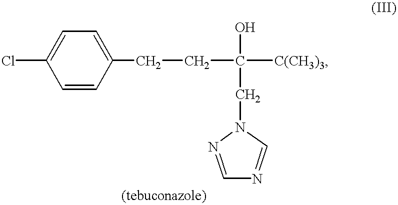

and/or

(3) an aniline derivative of the formula

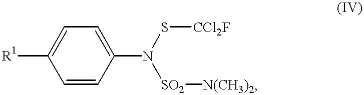

in which

R¹ represents hydrogen or methyl,

and/or

(4) N-[1-(4-chloro-phenyl)-ethyl]-2,2-dichloro-1-ethyl-3-methyl-cyclopropane-carboxamide of the formula

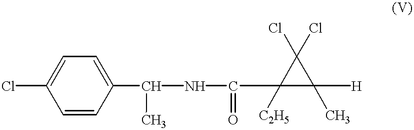

and/or

(5) the zinc propylene-1,2-bis(dithiocarbarmidate) of the formula

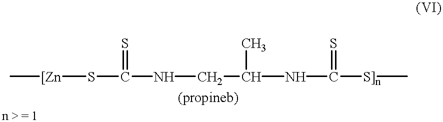

and/or

(6) at least one thiocarbarmate of the formula

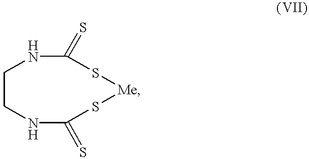

Me═Zn or Mn or a mixture of Zn and Mn

and/or

(7) the aniline derivative of the formula

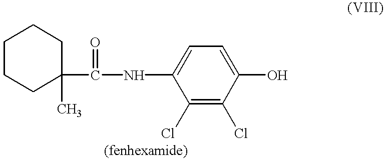

and/or

(8) the compound of the formula

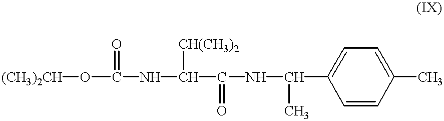

and/or

(9) the benzothiadiazole derivative of the formula

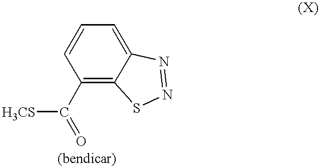

and/or

(10) the 8-t-butyl-2-(N-ethyl-N-n-propyl-amino)-methyl-1,4-dioxaspiro[5,4]-decane of the formula

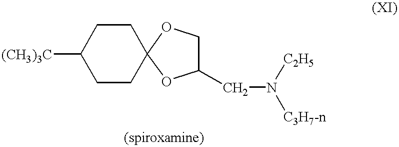

and/or

(11) the compound of the formula

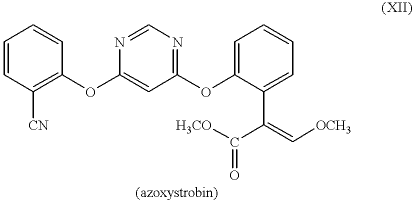

and/or

(12) the compound of the formula

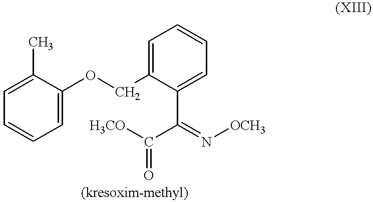

and/or

(13) the compound of the formula

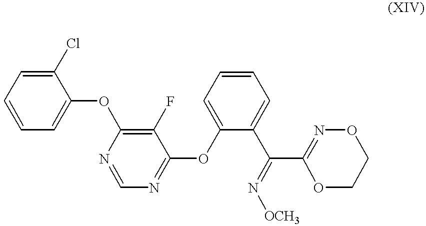

and/or

(14) the cyanooxime derivative of the formula

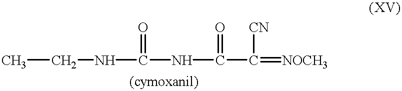

and/or

(15) a pyrimidine derivative of the formula

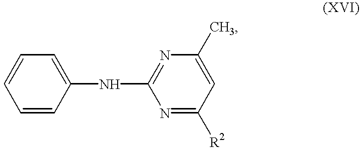

in which

R² represents methyl or cyclopropyl,

and/or

(16) the aniline derivative of the formula

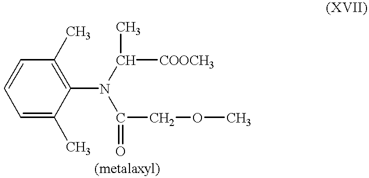

and/or

(17) the morpholine derivative of the formula

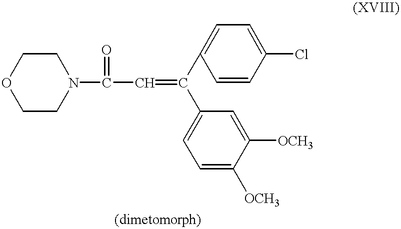

and/or

(18) the phthalimide derivative of the formula

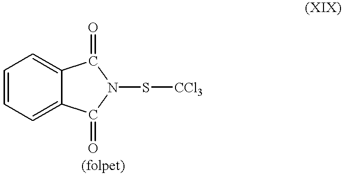

and/or

(19) the phosphorus compound of the formula

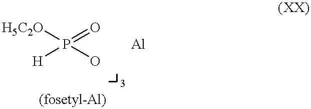

and/or

(20) the hydroxyethyl-triazole derivative of the formula

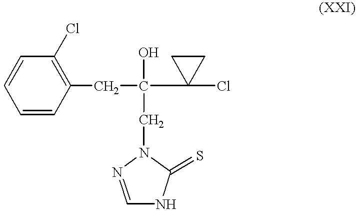

and/or

(21) the 1-[(6-chloro-3-pyridinyl)-methyl]-N-nitro-2-imidazolidineimine of the formula

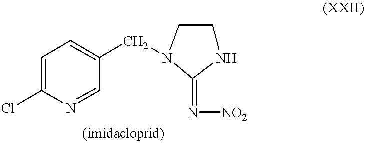

and/or

(22) the oxazohdinedione of the formula

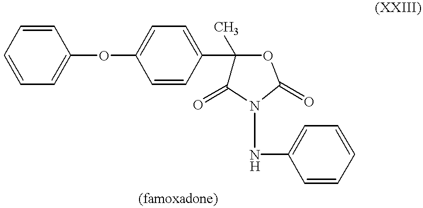

and/or

(23) the benzamide derivative of the formula

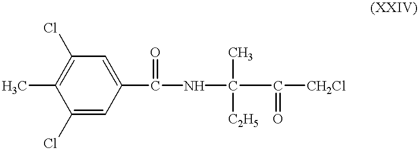

and/or

(24) a guanidine derivative of the formula

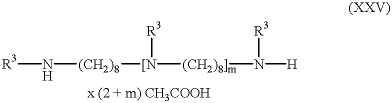

in which

m represents integers from 0 to 5 and

R³ represents hydrogen (17 to 23%) or the radical of the formula

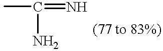

and/or

(25) the triazole derivative of the formula

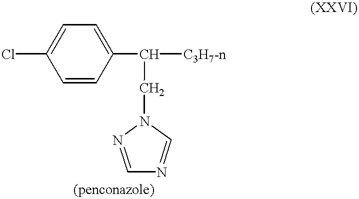

have very good fungicidal properties.

Surprisingly, the fungicidal activity of the active compound combinations according to the invention is considerably higher than the sum of the activities of the individual active compounds. Thus, an unforeseeable, true synergistic effect is present, and not just an addition of activities.

The formula (I) includes

the 1-(3,5-dimethyl-isoxazole-4-sulphonyl)-2-bromo6,6-difluoro[1,3]-dioxolo-[4,5f]-benzimidazole of the formula

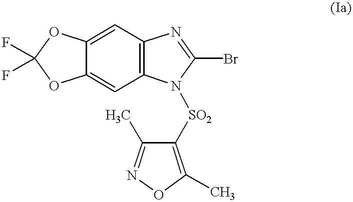

and

the 1-(3,5-dimethyl-isoxazole-4-sulphonyl)-2-chloro-6,6-difluoro-[1,3]-dioxolo-[4,5f]-benzimidazole of the formula

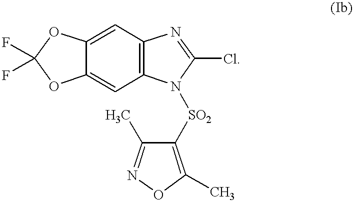

The halogeno-benzimidazoles of the formulae (Ia) and (Ib) are known (cf. WO 97-06171).

The formula (II) includes the compounds

1-(4chloro-phenoxy)-3,3-dimethyl-1-(1,2,4-triazol-1-yl)-butan-2-one of the formula

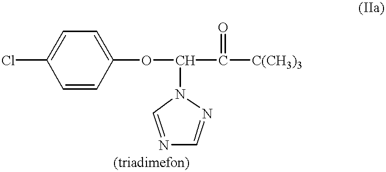

1-(4-chloro-phenoxy)-3,3-dimethyl-1-(1,2,4-trizol-1-yl)-butan-2-ole of the formula

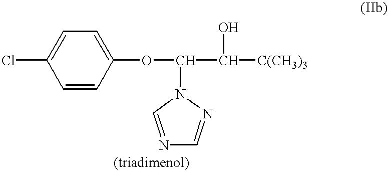

and

1-(4-phenyl-phenoxy)-3,3-dimethyl-1-(1,2,4-triazol-1-yl)-butan-2-ole of the formula

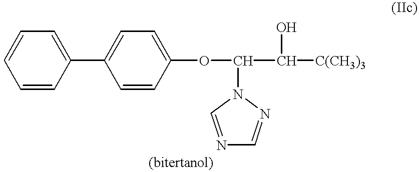

The formula (IV) includes the aniline derivatives of the formulae

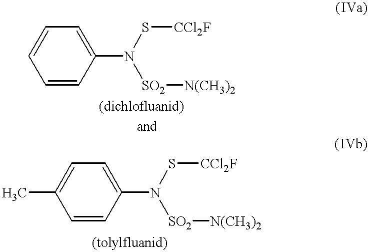

It is evident from the formula for the active compound of the formula (V) that the compound has three asymmetrically substituted carbon atoms. The product may therefore be present as a mixture of various isomers, or else in the form of a single component. Particular preference is given to the compounds

N-(R)-[1-(4-chloro-phenyl)-ethyl]-(1S)-2,2-dichloro-1-ethyl-3t-methyl-1r-cyclo-propanecarboxamide of the formula

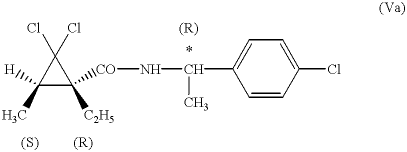

and

N-(R)-[1-(4-chloro-phenyl)-ethyl]-(1R)-2,2-dichloro-1-ethyl-3t-methyl-1r-cyclo-propanecarboxamide of the formula

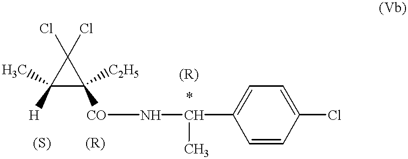

The formula (VII) includes the compounds

(VIIa) Me═Zn (zineb)

(VIIb) Me═Mn (maneb) and

(VIIc) mixture of (VIla) and (VIb) (mancozeb).

The formula (XVI) includes the compounds

(XVIa) R2═CH3 (pyrimethanil) and

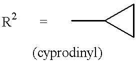

The hydroxyethyl-triazole derivative of the formula (XXI) can be present in the “thiono” form of the formula

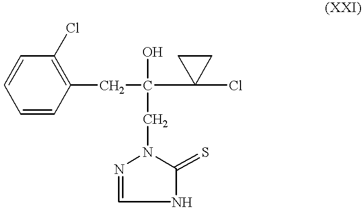

or in the tautomeric “mercapto” form of the formula

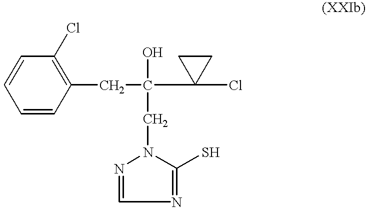

For the sake of simplicity, only the “thiono” form is given in each case.

The guanidine derivative of the formula (XXV) is a substance mixture of the common name guazatine.

The components which are present in the active compound combinations according to the invention in addition to a halogeno-benzimidazole of the formula (I) are also known. Specifically, the active compounds are described in the following publications:

(1) Compounds of the formula (II)

DE-A 2 201 063

DE-A 2 324 010

(2) Compound of the formula (III)

EP-A 0 040 345

(3) Compounds of the formula (IV)

Pesticide Manual, 9th Edition (1991), pages 249 and 827

(4) Compound of the formula (V) and individual derivatives thereof

EP-A 0 341 475

(5) Compound of the formula (VI)

Pesticide Manual, 9th Edition (1991), page 726

(6) Compounds of the formula (VII)

Pesticide Manual, 9th Edition (1991), pages 529, 531 and 866

(7) Compound of the formula (VIII)

EP-A 0 339 418

(8) Compound of the formula (IX)

EP-A 0 472 996

(9) Compound of the formula (X)

EP-A 0 313 512

(10) Compound of the formula (XI)

EP-A 0 281 842

(11) Compound of the formula (XII)

EP-A 0 382 375

(12) Compound of the formula (XIII)

EP-A 0 515 901

(13) Compound of the formula (XIV)

DE-A 196 02 095

(14) Compound of the formula (XV)

Pesticide Manual, 9th edition (1991), page 206

(15) Compounds of the formula (XVI)

EP-A 0 270 111

EP-A 0 310 550

(16) Compound of the formula (XVII)

Pesticide Manual, 9th Edition (1991), page 554

(17) Compound of the formula (XVIII)

EP-A 0 219 756

(18) Compound of the formula (XIX)

Pesticide Manual, 9th Edition (1991), page 431

(19) Compound of the formula (XX)

Pesticide Manual, 9th Edition (1991), page 443

(20) Compound of the formula (XXI)

WO 96-16048

(21) Compound of the formula (XXII)

Pesticide Manual, 9th Edition (1991), page 491

(22) Compound of the formula (XIII)

EP-A 0 393 911

(23) Compound of the formula (XXV)

EP-A 0 600 629

(24) Substance of the formula (XXV)

Pesticide Manual, 9th Edition (1991), page 461

(25) Compound of the formula (XXVI)

Pesticide Manual, 9th Edition (1991), page 654

In addition to an active compound of the formula (I), the active compound combinations according to the invention comprise at least one active compound of the compounds of groups (1) to (25). Additionally, they may comprise further fungicidally active components.

The synergistic effect is particularly pronounced when the active compounds in the active compound combinations according to the invention are present in certain weight ratios. However, the weight ratios of the active compounds in the active compound combinations can be varied within a relatively wide range. In general,

0.1 to 20 parts by weight, preferably 0.2 to 10 parts by weight, of active compound of group (1),

0.1 to 20 parts by weight, preferably 0.2 to 10 parts by weight, of active compound of group (2),

1 to 150 parts by weight, preferably 1 to 100 parts by weight, of active compound of group (3),

0.1 to 10 parts by weight, preferably 0.2 to 5 parts by weight, of active compound of group (4),

1 to 150 parts by weight, preferably 5 to 100 parts by weight, of active compound of group (5),

1 to 150 parts by weight, preferably 5 to 100 parts by weight, of active compound of group (6),

0.1 to 50 parts by weight, preferably 1 to 20 parts by weight, of active compound of group (7),

0.1 to 50 parts by weight, preferably 0.2 to 20 parts by weight, of active compound of group (8),

0.02 to 50 parts by weight, preferably 0.1 to 10 parts by weight, of active compound of group (9),

0.1 to 20 parts by weight, preferably 0.5 to 10 parts by weight, of active compound of group (10),

0.1 to 50 parts by weight, preferably 0.2 to 20 parts by weight, of active compound of group (11),

0.1 to 50 parts by weight, preferably 0.2 to 20 parts by weight, of active compound of group (12),

0.1 to 50 parts by weight, preferably 0.2 to 20 parts by weight, of active compound of group (13),

0.1 to 50 parts by weight, preferably 0.2 to 20 parts by weight, of active compound of group (14),

0.2 to 50 parts by weight, preferably I to 20 parts by weight, of active compound of group (15),

0.1 to 50 parts by weight, preferably 0.2 to 20 parts by weight, of active compound of group (16),

0.1 to 50 parts by weight, preferably 0.2 to 20 parts by weight, of active compound of group (17),

1 to 150 parts by weight, preferably 5 to 100 parts by weight, of active compound of group (18),

0.1 to 150 parts by weight, preferably 1 to 100 parts by weight, of active compound of group (19),

0.02 to 50 parts by weight, preferably 0.2 to 10 parts by weight, of active compound of (group (20),

0.05 to 20 parts by weight, preferably 0.1 to 10 parts by weight, of active compound of group (21),

0.1 to 50 parts by weight, preferably 0.2 to 20 parts by weight, of active compound of group (22),

0.1 to 50 parts by weight, preferably 0.2 to 20 parts by weight, of active compound of group (23),

0.02 to 50 parts by weight, preferably 0.04 to 10 parts by weight, of active compound of group (24) and/or

0.2 to 50 parts by weight, preferably I to 20 parts by weight, of active compound of group (25)

are employed per part by weight of active compound of the formula (1).

The active compound combinations according to the invention have very good fungicidal properties and can be employed for controlling phytopathogenic fungi, such as Plasmodiophoromycetes, Oomycetes, Chytridiomycetes, Zygomycetes, Ascomycetes, Basidiomycetes, Deuteromycetes, etc.

The active compound combinations according to the invention are particularly suitable for controlling cereal diseases, such as Erysiphe, Puccinia and Fusarium, and for controlling diseases encountered in viticulture, such as Uncinula, Plasmopara and Botrytis, and furthermore in dicotylendonous crops for controlling powdery and downy mildew fungi and causative organisms of leaf spot.

The fact that the active compound combinations are well tolerated by plants at the concentrations required for controlling plant diseases permits the treatment of above-ground parts of plants, of propagation stock and seeds, and of the soil. The active compound combinations according to the invention call be employed for foliar application or else as seed dressings.

The active compound combinations according to the invention can be converted to the customary formulations, such as solutions, emulsions, suspensions, powders, foams, pastes, granules, aerosols and microencapsulations in polymeric substances and in coating compositions for seeds, and ULV formulations.

These formulations are produced in a known manner, for example by mixing the active compounds or active compound combinations with extenders, that is liquid solvents, liquefied gases under pressure, and/or solid carriers, optionally with the use of surfactants, that is emulsifiers and/or dispersants, and/or foam formers. If the extender used is water, it is also possible to use, for example, organic solvents as auxiliary solvents. Essentially, suitable liquid solvents include: aromatics such as xylene, toluene or alkylnaphthalenes, chlorinated aromatics or chlorinated aliphatic hydrocarbons such as chlorobenzenes, chloroethylenes or methylene chloride, aliphatic hydrocarbons such as cyclohexane or paraffins, for example petroleum fractions, alcohols such as butanol or glycol and their ethers and esters, ketones such as acetone, methyl ethyl ketone, methyl isobutyl ketone or cyclolhexanone, strongly polar solvents such as dimethylformamide and dimethyl sulphoxide, or else water. Liquefied gaseous extenders or carriers are to be understood as meaning liquids which are gaseous at ambient temperature and under atmospheric pressure, for example aerosol propellants such as butane, propane, nitrogen and carbon dioxide. Suitable solid carriers are: for example ground natural minerals such as kaolins, clays, talc, chalk, quartz, attapulgite, montmorillonite or diatomaceous earth, and ground synthetic minerals such as finely divided silica, alumnina and silicates. Suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks. Suitable emulsifiers and/or foam formers are: for example nonionic and anionic emulsifiers, such as polyoxyethylene fatty acid esters, polyoxyethylene fatty alcohol ethers, for example alkylaryl polyglycol ethers, alkylsulpllonates, alkyl sulphates, arylsulphonates, or else protein hydrolysates. Suitable dispersants are: for example lignin-sulphite waste liquors and methylcellulose.

Tackifiers such as carboxymethylcellulose and natural and synthetic polymers in the form of powders, granules or latices, such as gum arabic, polyvinyl alcohol and polyvinyl acetate, or else natural phospholipids such as cephalins and lecithins, and synthetic phospholipids can be used in the formulations. Other additives can be mineral and vegetable oils.

It is possible to use colourants such as inorganic pigments, for example iron oxide, titanium oxide and prussian blue, and organic dyestuffs such as alizarin dyestuffs, azo dyestuffs and metal pbthalocyanine dyestuffs, and trace nutrients such as salts of iron, manganese, boron, copper, cobalt, molybdenum and zinc.

The formulations generally comprise between 0.1 and 95% by weight of active compounds, preferably between 0.5 and 90%.

In the formulations, the active compound combinations according to the invention can be present as a mixture with other known active compounds such as fungicides, insecticides, acaricides and herbicides, and as mixtures with fertilizers or plant growth regulators.

The active compound combinations can be used as such, in the form of their formulations or as the use forms prepared therefrom such as ready-to-use solutions, emulsifiable concentrates, emulsions, suspensions, wettable powders, soluble powders and granules. They are used in the customary manner, for example by watering, spraying, atomizing, scattering, spreading, and as a powder for dry seed treatment, a solution for seed treatment, a water-soluble powder for seed treatment, a water-soluble powder for slurry treatment, or by encrusting.

When using the active compound combinations according to the invention, the application rates can be varied within a relatively wide range, depending on the kind of application. In the treatment of parts of plants, the application rates of the active compound combination are generally between 0 1 and 10,000 g/ha, preferably between 10 and 1000 g/ha. In the treatment of seeds, the application rates of the active compound combination are generally between 0.001 and 50 g per kilogram of seed, preferably between 0.01 and 10 g per kilogram of seed In the treatment of the soil, the application rates of the active compound combination are generally between 0.1 and 10,000 g/ha, preferably between 1 and 5000 g/ha.

The good fungicidal activity of the active compound combinations according to the invention is evident from the examples below. While the individual active compounds exhibit weaknesses with regard to the fungicidal activity, the combinations have an activity which exceeds a simple addition of activities.

A synergistic effect of fungicides is always present when the fungicidal activity of the active compound combinations exceeds the total of the activities of the active compounds when applied individually.

The expected activity for a given combination of two active compounds can be calculated as follows (cf. Colby, S. R., “Calculating Synergistic and Antagonistic Responses of Herbicide Combinations”, Weeds 15, (1967), 20-22)

If

X is the efficacy when applying active compound A at an application rate of m g/ha,

Y is the efficacy when applying active compound B at an application rate of n g/ha, and

E is the efficacy when applying the active compounds A and B at application rates of m and n g/ha,

then

$$E = X + Y - \frac{X \cdot Y}{100}$$

The efficacy is calculated in %. 0% is an efficacy which corresponds to that of the control, while an efficacy of 100% means that no infection is observed.

If the actual fungicidal activity exceeds the calculated value, then the activity of the combination is superadditive, i.e. a synergistic effect exists. In this case, the efficacy which was actually observed must be greater than the value for the expected efficacy (E) calculated from the abovementioned formula.

The examples that follow illustrate the invention.

### EXAMPLE 1

Phytophthora test (tomato)/protective

| | |
|---|---|
| Solvent: | 47 parts by weight of acetone |
| Emulsifier: | 3 parts by weight of alkylaryl polyglycol ether |

To produce a suitable preparation of active compound, 1 part by weight of active compound or active compound combination is mixed with the stated amounts of solvent and emulsifier and the concentrate is diluted with water to the desired concentration, or a commercial formulation of active compound or active compound combination is diluted with water to the desired concentration.

To test for protective activity, young plants are sprayed with the active compound preparation at the stated application rate. After the spray coating has dried on, the plants are inoculated with an aqueous spore suspension of Phytophthora infestans. The plants are then placed in an incubation cabinet at about 20° C. and 100% relative atmospheric humidity.

Evaluation is carried out 3 days after the inoculation. 0% means an efficacy which corresponds to that of the control, while an efficacy of 100% means that no infection is observed.

Active compounds, application rates and test results are shown in the table below.

TABLE 1
Phytophthora test (tomato)/protective

| | Active compound | | |
|---|---|---|---|
| | application rate | Efficiacy | |
| Active compound | in g/ha | in % | |
| Known: | | | |
| 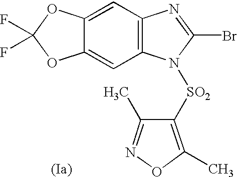 | 1 0.2 | 65 14 | |
| 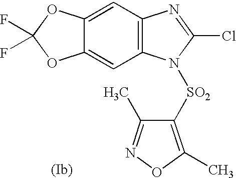 | 1 0.2 | 76 37 | |
| 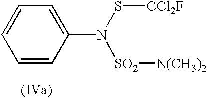 | 2 | 0 | |
| 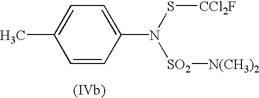 | 2 | 26 | |
| 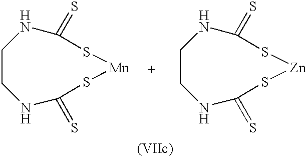 | 2 | 17 | |
| 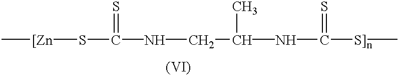 | 2 | 58 | |
| 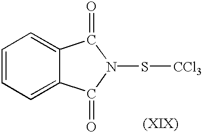 | 2 | 12 | |
| 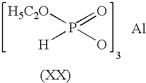 | 2 | 36 | |
| 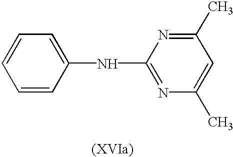 | 1 | 0 | |
| 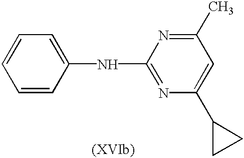 | 1 | 0 | |
| 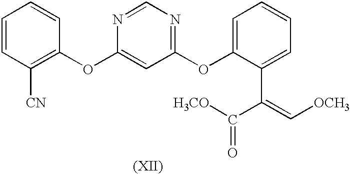 | 0.2 | 51 | |
| 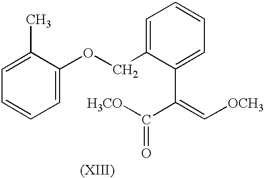 | 0.2 | 0 | |
| 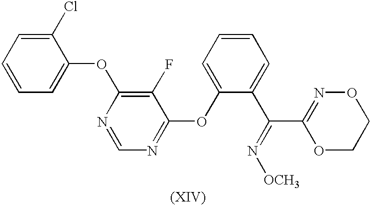 | 1 | 27 | |
| 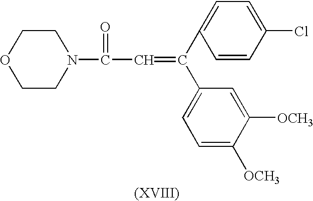 | 0.2 | 0 | |
| 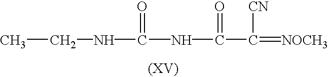 | 0.2 | 0 | |
| 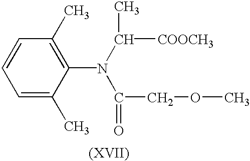 | 0.2 | 0 | |
| 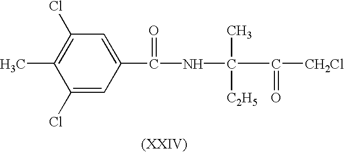 | 0.2 | 0 | |
| 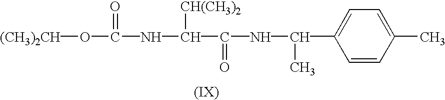 | 1 0.2 | 0 0 | |
| 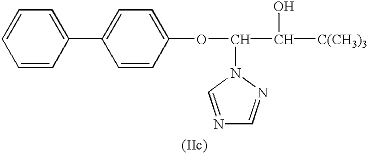 | 0.2 | 24 | |
| 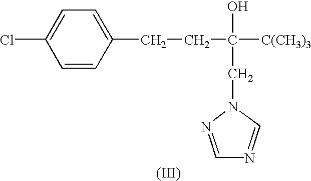 | 0.2 | 0 | |
| 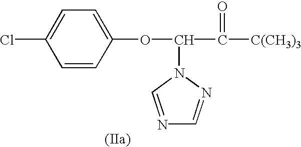 | 0.2 | 0 | |
| 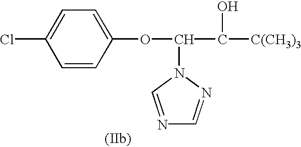 | 0.2 | 0 | |
| 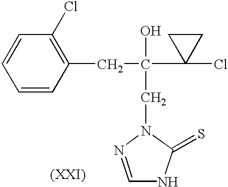 | 0.2 | 0 | |
| 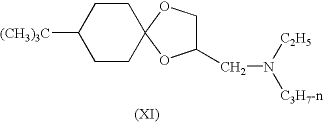 | 0.2 | 5 | |
| 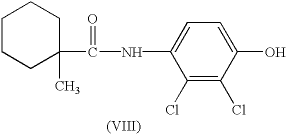 | 5 | 0 | |
| 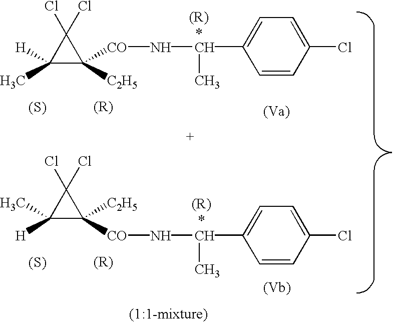 | 1 | 0 | |
| 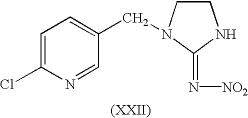 | 0.2 | 6 | |
| According to the invention: | | found | calc.*) |
| 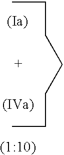 | 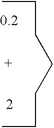 | 54 | 14 |
| 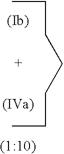 | 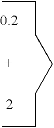 | 55 | 37 |
| 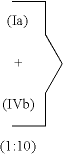 | 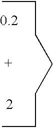 | 74 | 36 |
| 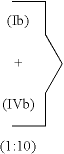 | 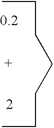 | 86 | 53 |
| 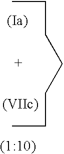 | 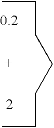 | 73 | 29 |
| 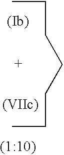 | 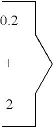 | 70 | 48 |
| 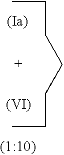 | 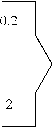 | 79 | 64 |
| 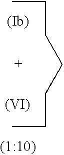 | 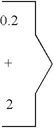 | 93 | 74 |
| 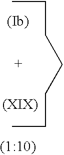 | 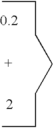 | 71 | 45 |
| 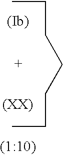 | 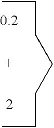 | 83 | 60 |
| 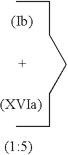 | 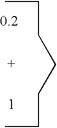 | 69 | 37 |
| 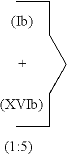 | 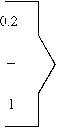 | 81 | 37 |
| 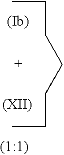 | 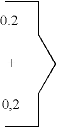 | 87 | 69 |
| 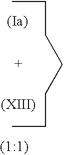 | 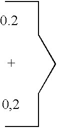 | 71 | 14 |
| 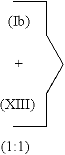 | 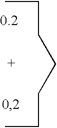 | 75 | 37 |
| 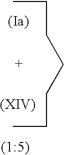 | 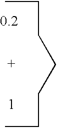 | 73 | 37 |
| 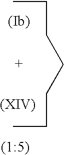 | 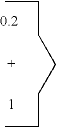 | 75 | 54 |
| 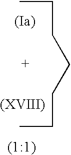 | 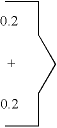 | 46 | 14 |
| 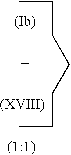 | 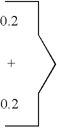 | 81 | 37 |
| 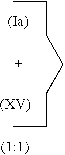 | 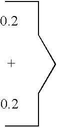 | 56 | 14 |
| 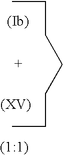 | 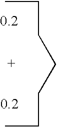 | 67 | 37 |
| 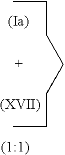 | 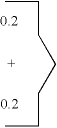 | 73 | 14 |
| 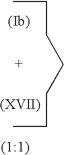 | 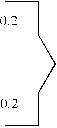 | 58 | 37 |
| 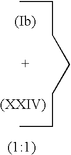 | 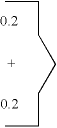 | 50 | 37 |
| 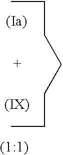 | 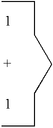 | 82 | 65 |
| 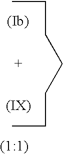 | 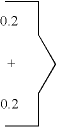 | 67 | 37 |
| 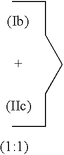 | 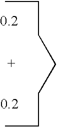 | 85 | 52 |
| 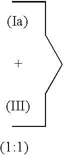 | 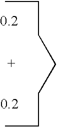 | 51 | 14 |
| 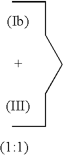 | 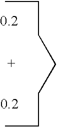 | 71 | 37 |
| 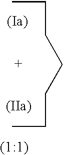 | 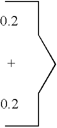 | 56 | 14 |
| 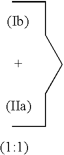 | 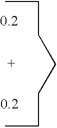 | 84 | 37 |
| 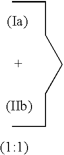 | 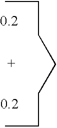 | 67 | 14 |
| 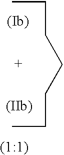 | 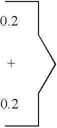 | 75 | 37 |
| 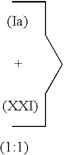 | 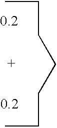 | 51 | 14 |
| 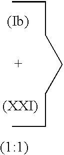 | 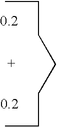 | 69 | 37 |
| 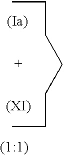 | 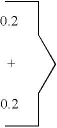 | 67 | 18 |
| 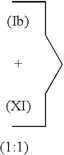 | 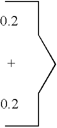 | 87 | 40 |
| 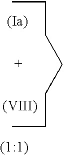 | 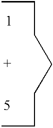 | 90 | 65 |
| 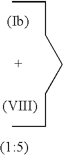 | 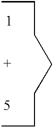 | 90 | 76 |
| 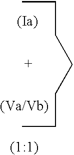 | 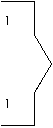 | 89 | 65 |
| 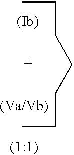 | 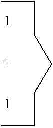 | 95 | 76 |
| 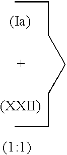 | 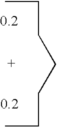 | 73 | 19 |
| 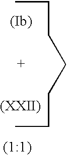 | 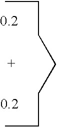 | 90 | 41 |

found = efficiacy found
calc. = efficiacy calculated using the Colby formula

### EXAMPLE 2

Fusarium nivale test (triticale)/seed treatment

The active compounds are applied as dry seed dressings. These are prepared by extending the respective active compound or the active compound combination with ground minerals to give a finely pulverulent mixture which ensures uniform distribution on the seed surface.

To dress the seed, the infected seed together with the seed dressing is shaken for 3 minutes in a sealed glass flask.

2×100 corns of triticale are sown at a depth of 1 cm in standard soil and cultivated in a greenhouse at a temperature of about 10° C. and a relative atmospheric humidity of about 95% in seed trays which receive a light regimen of 15 hours per day.

About 3 weeks after sowing, the plants are evaluated for symptoms. 0% means an efficacy which corresponds to that of the control, while an efficacy of 100% means that no infection is observed.

Active compounds, application rates and test results are shown in the table below.

TABLE 2
Fusarium nivale test (triticale)/seed treatment

| | Active compound | |
|---|---|---|
| | application rate in | |
| Active compound | mg/kg of seed | Efficacy in % |
| Known: | | |
| (Ia) | 100 | 26 |
| (Ib) | 500 | 0 |
| | 100 | 0 |
| (XXII) | 100 | 0 |
| (IX) | 500 | 0 |
| (VIIc) | 100 | 0 |
| (IVb) | 100 | 3 |
| Mixtures according to the | | |
| invention: | | |
| (Ia + VIIc) (1:1) | 50 + 50 | 66 |
| (Ib + XXII) (1:1) | 50 + 50 | 36 |
| (Ib + IX) (1:1) | 250 + 250 | 43 |
| (Ib + VIIc) (1:1) | 50 + 50 | 32 |
| (Ib + IVb) (1:1) | 50 + 50 | 75 |

### EXAMPLE 3

Pythium sp. test (pea)/seed treatment

The active compounds are applied as dry seed dressings. These are prepared by extending the respective active compound or the active compound combination with ground minerals to give a finely pulverulent mixture which ensures uniform distribution on the seed surface.

To dress the seed, the infected seed together with the seed dressing is shaken for 3 minutes in a sealed glass flask.

2×50 corns of seed are sown at a depth of 2 cm in compost soil naturally infected with phythium sp. and cultivated in a greenhouse at a temperature of about 20° C. in seed trays which receive a light regimen of 15 hours per day.

Evaluation is carried out after 14 days. 0% means an efficacy which corresponds to that of the control, while an efficacy of 100% means that no infection is observed.

Active compounds, application rates and test results are shown in the table below.

TABLE 3
Pythium sp. test (pea)/seed treatment

| | Active compound | |
|---|---|---|
| | application rate in | |
| Active compound | mg/kg of seed | Efficacy in % |
| Known: | | |
| (Ia) | 500 | 1 |
| (Ib) | 1000 | 4 |
| (VIIc) | 1000 | 8 |
| (IVb) | 1000 | 42 |
| | 500 | 37 |
| Mixtures according to the | | |
| invention: | | |
| (Ia + IVb) (1:1) | 250 + 250 | 55 |
| (Ib + VIIc) (1:1) | 500 + 500 | 38 |
| (Ib + IVb) (1:1) | 500 + 500 | 59 |

1. Fungicidal compositions, characterized in that they contain an active compound combination consisting of
a halogeno-benzimidazole of the formula 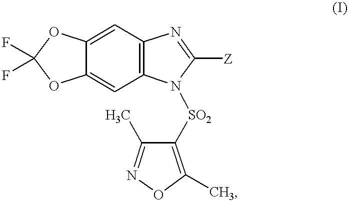
in which
Z represents chlorine or btomine, and
(1) a triazole derivative of the formula 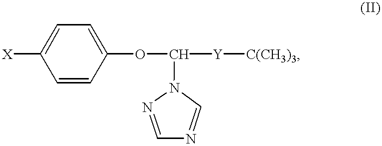
in which
X represents chlorine or phenyl, and 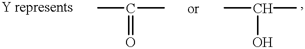
and/or
(2) the triazole derivative of the formula 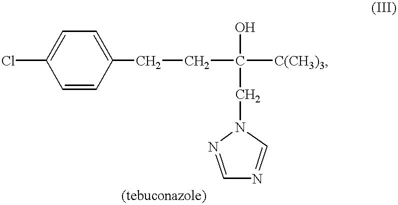
and/or
(3) an aniline derivative of the formula 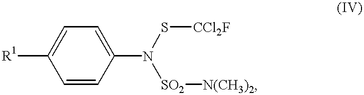
in which
R¹ represents hydrogen or methyl,
and/or
(4) N-[1-(4chloro-phenyl)-ethyl]-2,2-dichloro-1-ethyl-3-methyl-cyclo-propane-carboxamide of the formula 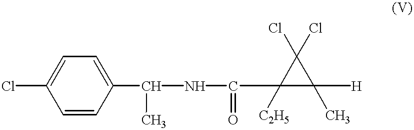
and/or
5 (5) the zinc propylene-1,2-bis(dithiocarbamidate) of the formula 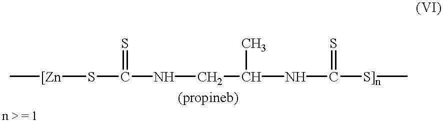
and/or
(6) at least one the carbamate of the formula 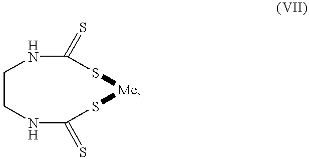
Me═Zn or Mn or a mixture of Zn and Mn
and/or
(7) the aniline derivative of the formula 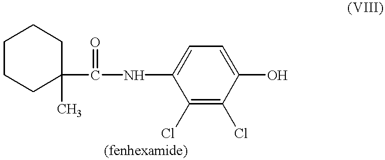
and/or
(8) the compound of the formula 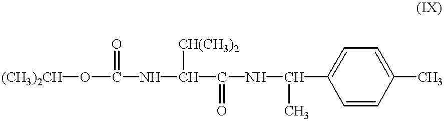
and/or
(9) the benzothiadiazole derivative of the formula 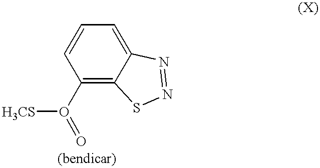
and/or
(10) the 8-t-butyl-2-(N-ethyl-N-n-propyl-amino)-methyl-1,4-dioxaspiro-[5,4]-decane of the formula 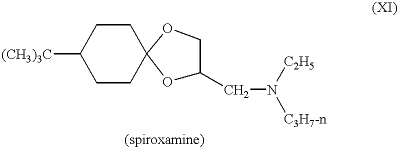
and/or
(11) the compound of the formula 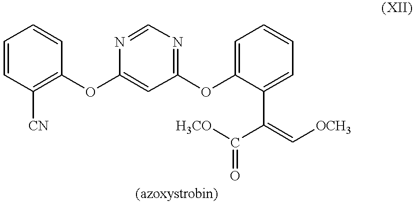
and/or
(12) the compound of the formula 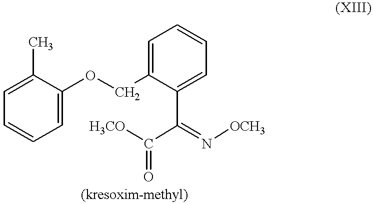
and/or
(13) the compound of the formula 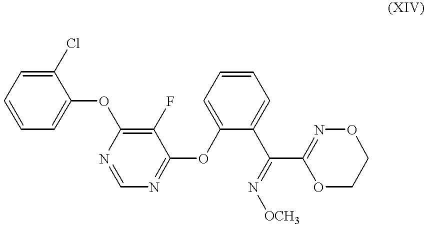
and/or
(14) the cyanooxime derivative of the formula 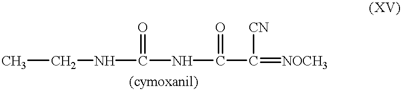
and/or
(15) at pyrimidine derivative of the formula 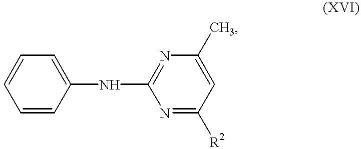
in which
R² represents methyl or cyclopropyl
and/or
(16) the aniline derivative of the formula 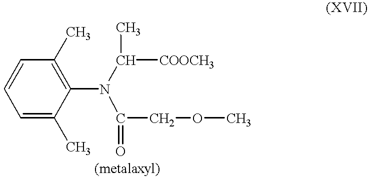
and/or
(17) the morpholine derivative of the formula 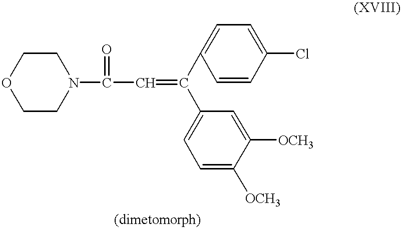
and/or
(18) the phthalimide derivative of the formula 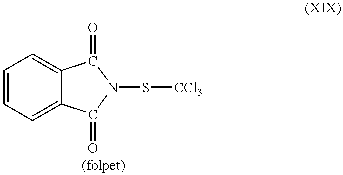
and/or
(19) the phosphorus compound of the formula 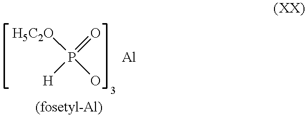
and/or
(20) the hydroxyethyl-triazole derivative of the formula 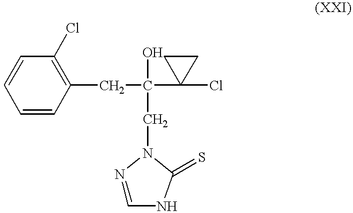
and/or
(21) the 1-[(6-chloro-3-pyridinyl)-methyl]-N-nitro-2-imidazolidineimine of the formula 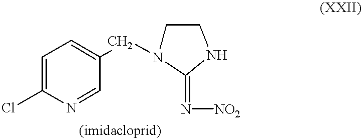
and/or
(22) the oxazolindinedione of the formula 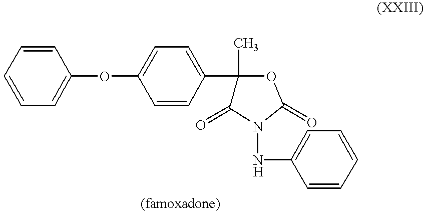
and/or
(23) the benzamide derivative of the formula 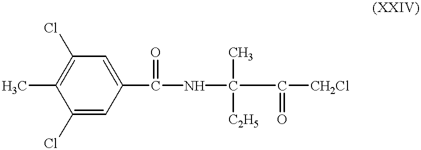
and/or
(24) a guanidine derivative of the formula 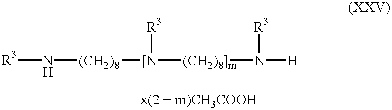
in which
m represents integers from 0 to 5 and
R³ represents hydrogen (17 to 23%) or the radical of the formula 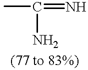
and/or
(25) the triazole derivative of the formula

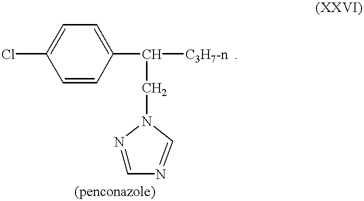

2. Composition according to claim 1 characterized in that in the active compound combinations the weight ratio of active compound of the formula (1) to
active compound of group (1) is between 1.0.1 and 1.20,
active compound of group (2) is between 1.0.1 and 1.20,
active compound of group (3) is between 1.1 and 1.150,
active compound of group (4) is between 1.0.1 and 1.10,
active compound of group (5) is between 1.1 and 1.150,
active compound of group (6) is between 1.1 and 1.150,
active compound of group (7) is between 1.0.1 and 1.50,
active compound of group (8) is between 1.0.1 and 1.50,
active compound of group (9) is between 1 0.02 and 1.50,
active compound of group (10) is between 1.0.1 and 1.20,
active compound of group (11) is between 1.0.1 and 1.50,
active compound of group (12) is between 1.0.1 and 1.50,
active compound of group (13) is between 1.0.1 and 1.50,
active compound of group (14) is between 1.0.1 and 1.50,
active compound of group (15) is between 1.0.2 and 1.50,
active compound of group (16) is between 1.0.1 and 1.50,
active compound of group (17) is between 1.0.1 and 1.50,
active compound of group (18) is between 1.1 and 1.150,
active compound of group (19) is between 1.0.1 and 1.150,
active compound of group (20) is between 1.0.02 and 1.50,
active compound of group (21) is between 1.0.05 and 1.20,
active compound of group (22) is between 1.0.1 and 1.50,
active compound of group (23) is between 1.0.1 and 1.50,
active compound of group (24) is between 1.0.02 and 1.50 and
active compound of group (25) is between 1.0.2 and 1.50

3. Method for controlling fungi characterized in that active compound combinations according to claim 1 are applied to the fungi and/or their habitat.

4. Use of active compound combinations according to claim 1 for controlling fungi.

5. Process for preparing fungicidal compositions characterized in that active compound combinations according to claim 1 are mixed with extenders and/or surfactants.
